(19) United States
(12) Patent Application Publication
(10) Pub. No.: US 2008/0109349 A1
(43) Pub. Date: May 8, 2008

(54) SYSTEM AND METHOD OF PROCESSING LOAN APPLICATIONS

(76) Inventors: George Jenich, Milwaukee, WI (US); Chuck Benedon, Germantown, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/557,578

(22) Filed: Nov. 8, 2006

(51) Int. Cl. G06Q 40/00

(52) U.S. Cl. 705/38

(57) ABSTRACT

A system and method of providing a loan applicant with a loan and a lending institution that will honor that loan. An application server receives application data and loan data and filters the loan data in light of the application data to determine a best available loan for the applicant. A signal is sent to the applicant indicating the best loans available to the applicant the application server receives a selection of a loan by the loan applicant, and notification is sent to a lending institution that will mediate the loan terms selected by the applicant.

### FIELD OF THE DISCLOSURE

The present disclosure relates to mortgage loan lead origination systems and a method of using thereof. More specifically, the present disclosure is related to a system and method by which a potential borrower chooses from available loan offerings and is thus empowered to make an educated loan offer to a lending institution based upon analysis of loans available to the potential borrower.

### BACKGROUND OF THE DISCLOSURE

When a potential borrower is looking for a loan, he must contact a variety of lending institutions. Each lending institution, in turn, requires that the potential borrower fill out a loan application and submit the application to the lending institution for processing. The lending institutions use the data from the loan application to determine the rates and terms upon which the lending institution would extend a loan to the potential borrower. This process is tedious and time-consuming for the potential borrower, and as such has the potential to dissuade the potential borrower from shopping around lending institutions to identify the best rate and loan terms available to the potential borrower. Not identifying the best rate and loan terms available can result in costing the potential borrower hundreds, if not thousands of dollars on loan fees and paid interest over the life of the loan. This is magnified for a potential borrower that may have less than perfect credit, and can result in greatly varying terms for loans offered to the potential borrower by each lending institution. Unfortunately, potential borrowers with less than perfect credit also tend to be less sophisticated about searching for potentially available loans and also may not have the disposable time to perform an extensive loan search by going lender to lender.

Automated loan processing systems taught in the prior art enable a potential borrower to search and/or view many different loan rates and loan terms offered by different lending institutions with a single online database. Many of these systems have searching and/or matching criteria that take a limited amount of borrower financial data and use this data to find loans offered by lending institutions that match the applicant's limited financial data. Upon the selection of a loan by the borrower, the system may provide the lending institution offering the loan selected by the borrower, the borrower's contact information, and/or prompt the borrower to fill out a loan application for that lending institution. Alternatively, the loan processing systems of the prior art may sell the borrower's contact and application data information to a number of lending institutions each of which may contact the borrower in the attempt to solicit the borrower's loan business.

Borrowers typically do not like to be bothered by listening to many sales pitches by various lending institutions. Furthermore, the lending institutions may use the initial contact with the borrower to convince the borrower to agree to less than favorable terms, or extend to the borrower additional financial products that the borrower does not need. Prior art systems may be billed as having banks compete for the business of offering the potential borrower a loan. However, even if banks are competing, the banks hold the cards and may still offer a less favorable loan to the borrower than the borrower is aware that he or she may be able to obtain. These loan processing systems do not recognize the true bargaining power that the potential borrower has if he or she has the proper information.

Therefore, it is desirable in the field of loan application processing for a system by which a potential borrower may educate themselves as to the best loan rates available to the borrower. This allows the borrower to extend a loan offer to a lending institution that the lending institution will accept based on the borrower's financial information.

### SUMMARY OF THE DISCLOSURE

In an embodiment, a system provides a loan applicant with a loan rate for a plurality of loan types that a lending institution will be interested in mediating, thereby empowering the loan applicant to make an offer to a lending institution at the rates and loan type most favorable to the borrower that the lending institution will accept. In an embodiment of the system, an application server is connected to a communications network for receiving application data from a loan applicant and the application server is connected to a loan information database comprising loan data for a plurality of loans offered by a plurality of lending institutions. More specifically, an embodiment of the system further comprises both prime and sub-prime loan server programs to process loan types ranging from the best of prime loans to the lowest of sub-prime loans, the servers being part of or connected to the application server and the loan information database. In a further embodiment, the application server processes the application data and the loan data to determine a plurality of loans for which the applicant qualifies.

In a further embodiment, the application server processes the loans for which the applicant is eligible to determine the loans that are available, and for which a lending institution will provide a loan on those terms.

In a further embodiment, the application server determines the best loan rates for each loan type available for the applicant from the available loans and signals for these loans to be displayed to the applicant.

In a further embodiment, the application server receives a selection by the applicant of one of the loans displayed to the applicant and notifies a lending institution of the applicant's selection of a loan offer.

In yet another embodiment, a method of providing a loan applicant with a loan rate and a lending institution that will mediate a loan at that rate comprises the steps of receiving application data from a loan applicant, receiving loan data from a loan information database, comparing the application data and the loan data to determine loans for which the applicant is eligible, filtering the loans to determine the best loan rates for each loan type available to the loan applicant, and notifying the loan applicant of the identified best loan rates.

In a further embodiment, the method further comprises the steps of receiving a loan selection from the loan applicant, and notifying a lending institution of the rate and terms offered by the loan applicant.

In a further embodiment, the method further comprises the steps of informing the applicant of the lending institution that has agreed to mediate the terms of the applicant's loan offer.

### BRIEF DESCRIPTION OF THE DRAWINGS

In the drawings:

FIG. 1 is a schematic diagram showing a system utilizing an embodiment of the system and method;

FIG. 2 is a generalized flow chart of an embodiment of the system and method; and

FIGS. 3a-3d depict a detailed flow chart of an embodiment of the system and method.

### DETAILED DESCRIPTION

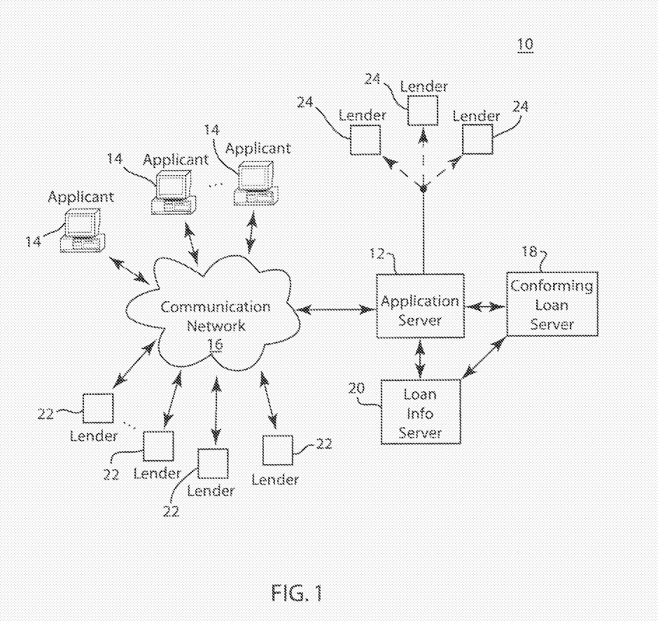

FIG. 1 depicts an embodiment of a loan processing system 10 utilizing an embodiment of the system and method. The loan processing system 10 comprises an application server 12. In an embodiment, the application server 12 performs the bulk of the functionality of the present invention. In a further embodiment, the application server 12 performs all of the functionality of the present invention. The application server 12 may be connected to a plurality of loan applicants 14 via a communication network 16. The loan applicants 14 may be each remotely located from the application server 12 and may interact with the application server 12 with a computer workstation associated with each applicant 14. The applicant 14 connects to the application server 12 through the communication network 16. The communication network 16 may be the internet, however, the communication network 16 may also be any variety of electronic communication networks 16 such as a LAN, WAN, or wireless connections such as cellular, RF, or Bluetooth, or any connecting terminal for a device such as a laptop, PDA, or cellular phone, depending on the communication needs of the loan processing system 10.

The application server 12, which may comprise any server or computer processor capable of performing the functions herein described of the application server 12, may comprise the quality of scalability to facilitate the application server's ability to handle periods of high processing demand. The application server 12 may be connected to an additional conforming loan server 18 wherein the conforming loan server 18 processes applicant data and loan data regarding inquires into loans that are considered to be conforming or prime loans based upon the applicants financial desirability and the terms of the loans available. Alternatively, the system 10 may further comprise a non-conforming loan server (not depicted) wherein the application server may signal the non-conforming loan server to processes non-conforming, sub-prime, or any other types of loans. However, in the embodiment depicted in FIG. 1, the application server 12 may comprise the functionality to process the sub-prime loans. In a still further embodiment, the application server 12 may comprise the functionality to process both the prime and sub-prime loan requests by an applicant.

The application server 12 may further be connected to a loan information server 20. The loan information server 20 may comprise loan data regarding a plurality of loans available from a plurality of lending institutions. The plurality of loans may include a variety of loan types and different loan rates offered for each of the loan types by each of the lending institutions represented in the database. The loan information server 20 may have received the loan data by a variety of means, these means may comprise the entry of the loan data by a technician, or may comprise an automated system (not depicted) whereby the loan information server 20 accesses the communication network 16 and thereby accesses loan data available from a plurality of lending institutions 22. In an embodiment of the loan processing system 10, the application server 12 comprises the functionality to access the plurality of lending institutions 22 to obtain loan data via the communication data network 16. In an alternative embodiment the application server 12 may comprise the functionality to access the websites of a plurality of lending institutions 22 and obtain loan data from the websites. The application server 12 then stores the loan data in the loan information server 20.

In an alternative embodiment, the application server 12 further comprises the loan information server 20 such that the loan processing system 10 only requires a single server to perform the loan processing. In an alternative embodiment the loan information server 20 has the functionality to collect and store loan data from a plurality of lending institutions 22.

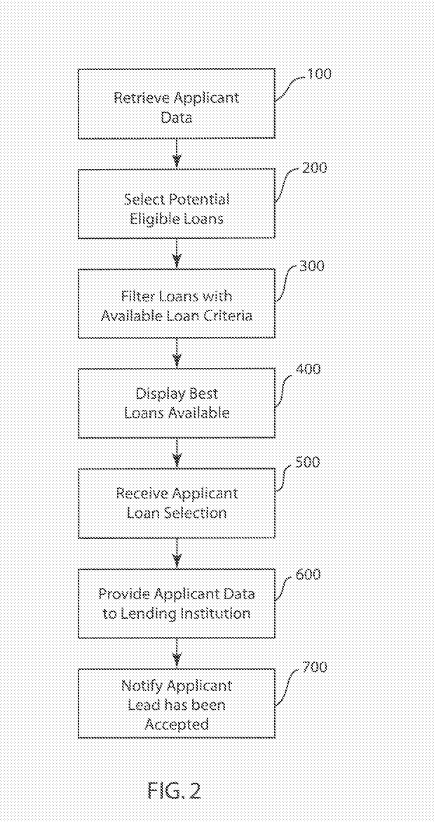

FIG. 2 depicts a general flow chart of an embodiment of the functionality of the system and the method. This embodiment will be explained in further detail with reference to the physical structures shown in FIG. 1. First, at 100, the application server 12 receives applicant data. The application server 12 may receive the application data from any one of a plurality of applicants 14 who access the application server 12 through the communication network 16 using a remotely located computer terminal that is associated with the applicant 14. In embodiments, the computer terminal may be a laptop, PDA, or cell phone; however, this list is merely exemplary and is not intended to be limiting on the scope of the present invention. Alternatively, the applicant data may be entered into the application server directly by a local terminal, which may be operated by a loan applicant, an employee, by a loan brokering service or a lending institution. Alternatively, the applicant data may be entered through alternative ways of assessing a database such as referring asp.net website or a third party referred and/or affiliate service. As the application server 12 receives application data, the application server 12 may process the data to check the validity of such data, and may save the application data for later use.

Next, at step 200, the application server 12 selects potential loans for the applicant 14 for which the applicant is eligible from the loan information server 20. The application server 12 may select the eligible loans at step 200 by processing some of the applicant data and comparing it to the loan data in the loan information server, such as eligibility requirements that are associated with each of the loans in the loan information server. Alternatively, at 200, the application server 12 may determine that the applicant 14 may qualify for a prime loan, and may direct the applicant data to the conforming loan server 18 for processing a prime loan based upon eligible prime loans in the loan information server 20. After the application server 12 has identified loans for which the applicant 14 is eligible, the application server 12 then filters the eligible loans in step 300 with data from a plurality of lending institutions 24 for which there is a working relationship with the operator of the application server 12. The lending institutions 24 may or may not be any of the lending institutions 22 from which the loan data was originally obtained, or the lending institutions 24 may be none of the lending institutions 22 from which the loan data was obtained. Rather, the lending institutions 24 are lending institutions with which a working relationship has been developed. Alternatively, if a lending institution is operating the application server 12, then the lending institution may use their own data or that of one of its affiliates. The application server 12 uses lending institution data to filter the eligible loans to determine which of the lending institutions 24 will honor the terms of the loans for which the applicant is eligible.

Next, in step 400, the application server 12 further filters the available loans to determine the best loan rates for the applicant from the loans available to the applicant. This filtering process may comprise eliminating available loans that are clearly superseded by the terms of other available loans. Alternatively, the application server 12 may comprise a hierarchy of criteria upon which the available loans are rated and the best loan rates identified using this system are displayed to the applicant. Alternatively, in an embodiment, the applicant may select criteria upon which the available loans are rated. In an embodiment, the application server 12 or the applicant 14 may determine a specific number of the best loans available to display to the applicant 14. The number of loan rates that are displayed to the applicant 14 may be a single best loan rate, the best loan rate in each of a plurality of loan types, or 5, 10, or any other specified number of best loans to be displayed. The loan types may comprise general loan types such as 30 year fixed, 15-year fixed, 3-year arm or 7-year arm, or any other type of loan that may be available to a loan applicant 14. The application server 12 then sends a signal through the communication network 16 to the applicant 14 for displaying the best available loan rates to the applicant 14.

At 500 the applicant 14 views the best available loan rates that are displayed to the applicant 14 and makes a selection from the displayed loan rates. This selection is sent back to the application server 12 through the communication network 16, thereby indicating to the application server 12 the selection that the applicant 14 has made.

After the application server 12 has received the applicant's selection, the application server 12, at step 600, provides the applicant's data and the loan terms from the loan offered by the applicant 14 to the lending institution 24 that will mediate the terms of the loan offered by the applicant 14. Additionally, at step 700 the application server 12 notifies the applicant 14 that the loan selected by the applicant 14 has been accepted by the lending institution 24 and the applicant 14 may then receive the contact information for the lending institution 24.

In an embodiment, steps 600 and 700 may be performed by an automated system comprising the application server 12 wherein an electronic message, such as an email, may provide the applicant data to the lending institution 24 and the lending institution data to the applicant 14. In a still further embodiment, the applicant 14 and the lending institution 24 may receive a notification email indicating that a match has been made between the applicant's selected loan offer and a lending institution willing to mediate that loan offer. The automated notification may direct the applicant 14 to a website secured by a password whereby the applicant 14 may gain access to the contact information of the lending institution 24 that has accepted the applicant's loan offer. Additionally, the lending institution 24 that has accepted the applicant's loan offer, would similarly receive a notification email directing the lending institution 24 to a similar password protected website to gain access to the applicant's contact information to continue the loan process. Even if no loan data is found by the databases, the application may still be sent to a lending institution to review the application/file to see if there is any possibility to conduct further investigation in an effort to find a particular niche/non published product that my fit the applicant's needs.

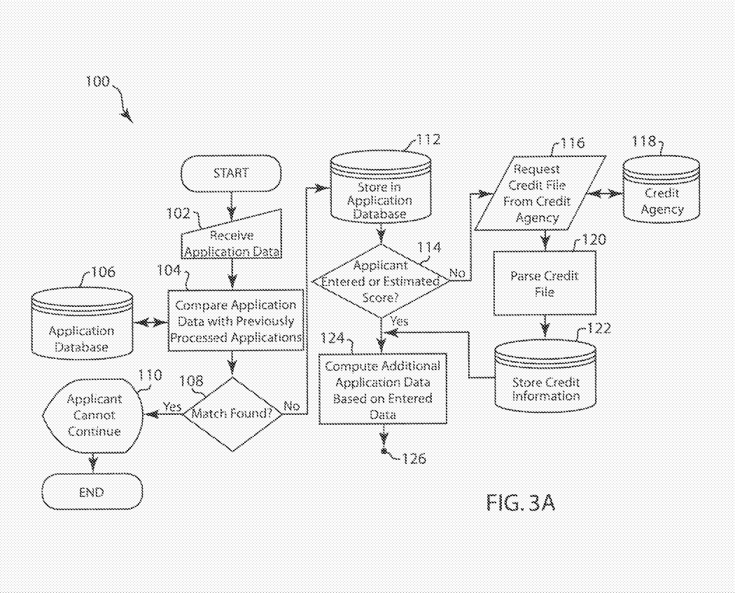

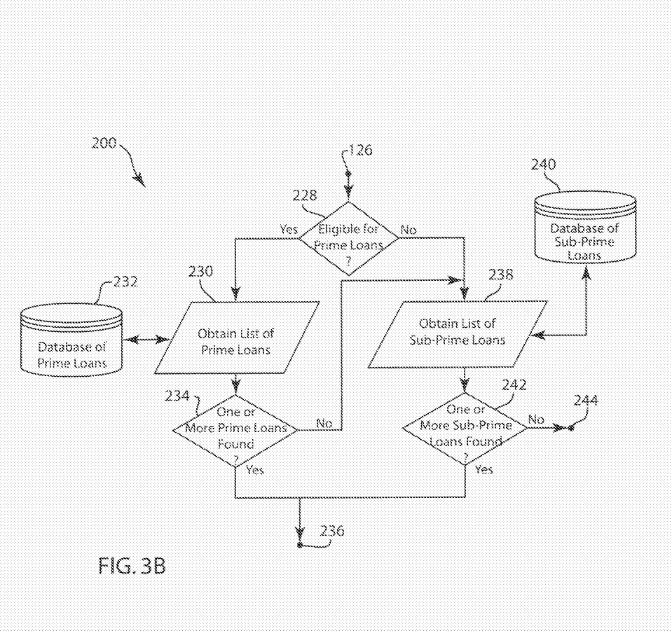

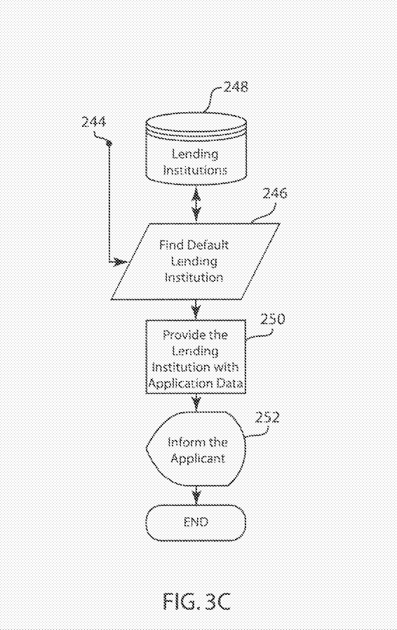

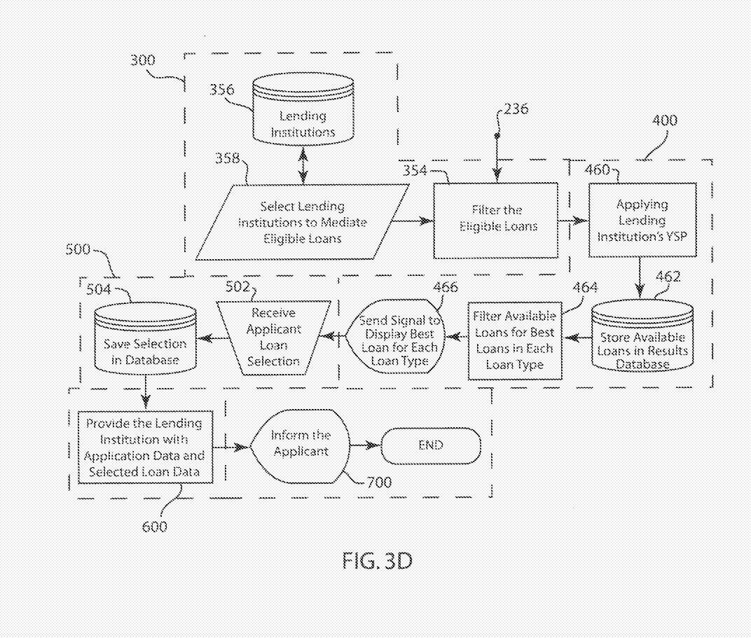

A more detailed description of an embodiment of the system and method as described in accordance to FIG. 2 is depicted in FIGS. 3a-3d. FIG. 3a is a flow chart describing an embodiment of the steps that may be enacted in accordance with step 100. First at step 102 the application server 12 receives application data from the applicant 14. The application server 12 then may compare the application data with existing application data processed previously by the application server 12 to determine if the applicant 14 has applied using the application server 12 before in step 104. The application server 12 may use a database 106 of processed applications to aid in the comparison in step 104. The comparison in step 104 may be performed to limit the number of times an applicant may apply for a loan through the application server 12 within a specific time period. If a match is identified in step 108, the applicant cannot continue in step 110 and may receive a message indicating why the applicant may not continue, and when the applicant may be eligible to use the system again. If no match is found between the application data received in step 102 and the applications that have already been processed from the database 106, then the application data received in step 102 may be stored in the application database 106 in step 112.

Next, the application server 12 may check in step 114 to see if the applicant 14 entered his or her credit score in the application data. If the applicant did not enter a credit score then the application server 12 may initiate a request for a credit score from a credit agency in step 116. In an embodiment, a specific credit agency 118 may be used by the application server 12 to obtain the applicant's credit file. In an alternative embodiment, the applicant may select the credit agency from which the applicant's credit file will be obtained. Next, at step 120, the application server 12 may parse the obtained credit file to retrieve the necessary credit information from the credit file obtained in step 116. In step 122, the necessary credit information pulled out in step 120 may be stored in a credit information database, the database being compliant with current Federal protocols and procedures. The necessary credit information may include the applicant's credit score, but may also include payment history data or outstanding debt; however, these examples are not meant to be limiting as to the scope of the credit information stored in step 122.

Therefore, whether or not the applicant entered a credit score with the application data, at step 124 the application server 12 has access to the applicant's credit information to create a complete set of applicant application data. At step 124 the application server 12 computes additional application data from the data entered by the applicant and retrieved from the applicant's credit history. The additional data computed in step 124 may comprise the applicant's debt ratio or a determination of the “seasoning,” or minimum credit history of a line of credit in the credit report. Alternatively, embodiments may compute an applicant's gross income, or monthly disposable income. Furthermore, quantification or qualification of any of the trade lines in the applicant's credit history may be obtained. However, these examples are merely exemplary and are not intended to be limiting as to the scope of additional data for an applicant that the application server 12 may compute. The description of this embodiment continues at reference location 126 on FIG. 3b.

FIG. 3b is a continuation of the flow chart depicted in FIG. 3a in reference to the step of selecting potential eligible loans 200.

First, the application server 12 determines whether the application data makes the applicant eligible for a prime loan in step 228. This determination may be based upon a comparison of application data to minimum financial requirements associated with loans in the loan information server 20, such as the loan to value ratio, or many other financial indications that may be used to determine loan eligibility. If the applicant is eligible for a prime loan the application server 12 may send a signal to a conforming loan server 18 for the conforming loan server 18 to continue processing the application data. First, the conforming loan server 18 would obtain a list of prime loans in step 230. The list of prime loans may be retrieved from a database of prime loans 232 that may be associated with the loan information server 20. The list of prime loans may further comprise the adjusted loan rates based upon the lending guidelines and application criteria for a specific lending institution. If one or more prime loans for which the applicant is eligible are identified in step 234, then the one or more prime loans are forwarded to reference 236. Alternatively, steps 230-234 may be performed by the application server 12 without the need for a separate conforming loan server 18.

If no prime loans for which the applicant is eligible are found in the database of prime loans 232, or the applicant is not eligible for prime loans in step 228, the application data is sent to step 238. Step 238 may be performed by the application server 12 or may be performed by a sub-prime loan server. In step 238 the application server 12 obtains a list of sub-prime loans for which the applicant may be eligible. The eligible loans may be retrieved from a database of sub-prime loans 240 which may be associated with the loan information server 20. The database of sub-prime loans 240 may comprise the adjusted rates for each of the eligible sub-prime loans. The adjusted rates may be based on the lender's guidelines and application criteria that may be associated with each of the sub-prime loans in the database of sub-prime loans 240.

Next, at step 242 it is determined whether one or more sub-prime loans for which the applicant is eligible were found in step 238. If at least one sub-prime loan was found, the eligible loans are forwarded to reference 236. If no sub-prime loans were found, then a signal is sent to reference 244.

FIG. 3c is an embodiment of the continuation of the flow chart depicted in FIG. 3b. The flow chart depicted in FIG. 3c depicts the steps that are performed in an embodiment if no sub-prime loans for which the applicant is eligible are found in step 238 and a signal is sent to reference 244. Often, this result is based upon errors in the application data, or incomplete application data rather than on the applicant being unqualified for any loan. Therefore, it is desirable to identify a lending institution for the applicant to contact to work out any problems with the applicant's entered application data. Continuing with reference 244, the application server 12 then proceeds to step 246 of finding a default lending institution 24 from a database of lending institutions 248. The database of lending institutions 248 may be associated with the application server 12, the loan information server 20, or may be a database that is not a part of either the application server 12 or the loan information server 20. The default lending institution 24 may be identified as a lending institution that commonly issues loans for property within the particular state that the application desires to obtain a loan.

Upon finding a default lending institution 24 in step 246, the application server 12 may then provide the lending institution 24 with the application data in step 250 so that a representative from the default lending institution 24 may personally review the application data and contact the applicant 14 to discuss any options that the applicant 14 may have. Finally, at step 252 the applicant may be informed that the applicant's application data has been forwarded to the default lending institution. The lending institution 24, and/or the applicant 14 may receive the data in steps 250 and/or step 252 via email or other communications means utilizing the communication network 16.

FIG. 3d depicts an embodiment of the continuation of the steps of the embodiment depicted in FIG. 3b and showing an embodiment of a more detailed implementation of steps 300, 400, 500, 600, and 700.

Starting with reference 236, in step 354 the loans for which the applicant is eligible are filtered. The eligible loans are filtered using a database 356 of lending institution data from a plurality of lending institutions 24 for which there is a working relationship for providing loans to a loan applicant. The database of lending institutions 356 may comprise a variety of data from lending institutions 24 indicating the loans that a lending institution 24 in the database of lending institutions 356 would be willing to provide to an applicant if an applicant selected to offer the lending institution those loan terms.

In an embodiment, the lending institutions 24 in the database of lending institutions 356 and the lending institutions 22 from which the loan terms were originally obtained are not the same lending institutions. It is understood that some of the lending institutions 24 and lending institutions 22 may be the same, however the number of common lending institutions between lending institutions 22 and lending institutions 24 is inapposite. Rather, lending institutions 24 that have a working relationship with the operator of the application server 12 are preferred. In an embodiment, a lending institution is operating the application server 12, the lending institutions competitors are the lending institutions 22 and the lending institution and its affiliates are the lending institutions 24.

In step 358 lending institutions 24 are identified that are interested in mediating a loan for the applicant 14, particularly a loan at the loan rates previously identified as those for which the applicant 14 is eligible. This selection may be based upon both the willingness of the lending institution 24 to mediate the loan and the state within which the loan will be made and the states in which the lending institution 24 is qualified to provide loans. Therefore, in step 354 the loan rates and loan types that are available to the applicant 14 are determined. An available loan rate is one that the applicant 14 is both eligible for, and a lending institution 24 will mediate.

Next, the available loan rates or the loan rates for which the applicant is both eligible for and a lending institution is willing to mediate a loan type at that loan rate, are forwarded to step 460 where the lending institution's yield spread pricing (YSP) may be applied to each of the available loan rates. The YSP may vary between each lending institution 24 that is willing to mediate an available loan. Some lending institutions 24 may not apply a YSP to some or all of the available loan rates. The available loan rates are then stored in a results database in step 462. Next, in step 464 the available loans are filtered to determine the best loan rates that are available for each loan type. The filtering performed in step 464 may be based upon criteria established by the applicant or that may be established in the application server 12. The addition of a YSP by a lending institution 24 in step 460 may further affect which of the loans are the best available for a loan type. In an embodiment, the application server 12 or the applicant 14 may define the number of best loan rate for each type to return to the applicant 14. In a further embodiment, the application server 12 only returns back to the applicant 14 the single best available loan rate for each loan type.

Once the best available loan rates are identified in step 464, the application server 12 may a send a signal via the communications network 16 to the applicant 14 to display to the applicant 14 the specified number of best loan rates for each loan type. As may be determined by the applicant 14 or the by application server 12, the display of the best loan rate for each loan type in step 466 may include the display of more than one loan rate for each loan type. In a still further embodiment, all of the available loan rates for each available loan type are displayed to the applicant 14, however the applicant 14 is only able to select rates identified as being one of the best rates for each loan type.

Next, in step 502 the application server receives back from the applicant 14 via the communications network 16 a selection of one of the loans displayed to the applicant. The loan rate selected may then be saved with the applicant's data in a selection database 504 that may be associated with the application server 12.

Next, in step 600, the lending institution 24 that is interested in mediating the loan that is provided with the application data, and the loan data for the selected loan rate and type. As previously described, this notification in step 600 may be performed via an email message comprising the application data and the loan data, or may be provided by a notification email directing the lending institution 24 to access a secure website whereby the lending institution gains access to the application data and the loan data; however, many other notification forms and systems may be used in accordance with the present invention. Finally, in step 700 the application server 12 notifies the applicant 14 of the lending institution 24 that will mediate a loan according to the loan rate and type offered by the applicant.

Alternatively, the lending institution 24 that will mediate a loan for the applicant 14 at the loan rate and type offered by the applicant 14 may be provided with the loan data for all of the loans that were available to the applicant 14. The lending institution 24 may be presented with all of the loan data despite the applicant 14 not receiving the loan data. In an alternative embodiment, the lending institution 24 only receives the loan data that the applicant 14 receives.

In an embodiment, the application server 12, as another associated server (not depicted), also identifies a real estate agent for the applicant 14 to contact if the applicant needs a real estate agent. The applicant 14 may indicate that a real estate agent is needed as part of the applicant's application data. The application server 12 may then filter records of real estate agents in the applicant's area or in the area in which the applicant desires to make a purchase.

Embodiments present advantages to the loan applicant that are desirable in the field of loan application processing. Embodiments provide a loan applicant with access to the best available loan rates and loan types for which the applicant may qualify and empowers the applicant with an increased knowledge of the available loan market, thus allowing the applicant to make an offer to a lending institution of the best loan terms that are available to that applicant. In an embodiment, the applicant further benefits by only being in contact with a single lending institution, whereby the applicant is not bothered by numerous lending institutions desiring to sell the applicant other financial products that the applicant does not need in addition to the loan that the applicant wants to obtain. In an embodiment, the applicant further benefits in that the applicant's information is kept secure and only released to a single lending institution, whereby only one lending institution contacts the applicant in regard to the loan desired by the applicant.

A still advantage of an embodiment is that since the application data is entered through the communications network and the filtering is performed using algorithms programmed into the application server, the applicant can be assured that the loan rates provided to the applicant are gender and race neutral. Additionally, the acceptance of the applicant's offer by a lending institution is done on a gender and race neutral basis. Therefore, embodiments help to eliminate any lending determinations by lending institutions with a preconceived notion in regards to lending to a particular race or gender.

Embodiments further provide advantages to lending institutions that receive the application data in that the application data is in a more complete state, including an applicant's credit score and any computed application data when the lending institution receives the application data. By receiving a more complete set of application data, the lending institution can be confident in the qualifications of the applicant for the loan offer made by the applicant. The lending institution farther sees the advantage that less time is needed to complete the loan application as the application data is nearly complete for the loan processing.

Embodiments further exhibit advantages to those in the business of providing loan applicant leads to a lending institution, in that while loan data from a plurality of lending institutions is used to formulate the best available for an applicant, the applicant data may be sent to any lending institution willing to match the terms offered by a competitor. Therefore, banks truly are competing over the best available rate that is offered by the applicant.

This written description uses examples to disclose the invention, including the best mode, and also to enable any person skilled in the art to make and use the invention. The patentable scope of the invention is defined by the claims and may include other examples that occur to those skilled in the art. Such other examples are intended to be within the scope of the claims if they have structural elements that do not differ from the literal language of the claims, or if they include equivalent structural elements of insubstantial difference from the literal language of the claims.

Various alternatives and embodiments are contemplated as being with in the scope of the following claims, particularly pointing out and distinctly claiming the subject matter regarded as the invention.

What is claimed is:

1. A system for matching a loan applicant with a loan and a lending institution that will provide that loan, the system comprising:
an application server; and
a communications network connected to the application server, the application server being configured for storing a computer application, and fuirther configured to execute the computer application; such that when the application server executes the computer application;
wherein when the application server executes the computer application, the server receives application data over the communication network from at least one loan applicant, receives loan data for a plurality of loans from a loan information database, compares the application data and the loan data for the plurality of loans to determine a plurality of eligible loans, filters the plurality of eligible loans to determine a plurality of available loans, filters the available loans to determine a best loan, sends a signal to a loan applicant via the communications network indicating the best loan to the loan applicant, receives a selection of the best loan from the loan applicant, sends a notification to a lending institution upon receiving the selection of the best loan from the loan applicant, and sends a notification to the loan applicant that the lending institution has been notified of the selection of the loan applicant.

2. The system of claim 1 wherein the application server is further programmed to compute additional application data, the additional application data being added to the application data, and the application data being used to determine a plurality of eligible loans.

3. The system of claim 2 wherein the at least one best loan comprises at least one best loan for each of a plurality of loan types.

4. The system of claim 1 wherein the notifications to the lending institution and the loan applicant are emails.

5. The system of claim 4 wherein the emails are automatically generated by the application server after receiving a selection of the best loan from the loan applicant.

6. The system of claim 4 wherein the email to the lending institution directs a representative of the lending institution to a secure website to obtain the application data.

7. The system of claim 4 wherein the email to the loan applicant directs the loan applicant to a secure website to applicant data and loan data.

8. The system of claim 1 wherein none of the loan data in the loan information database is loan data associated with the lending institution.

9. The system of claim 1 wherein the application server receives edits to application data received from the loan applicant.

10. The system of claim 1 further comprising a real estate agent database comprising real estate agent contact information; wherein the application data further comprises an indication to select a real estate agent and the application server filters the real estate agent database to identify a real estate agent for the applicant and sends a signal for the real estate agent contact information to be displayed to the applicant.

11. A system for providing a loan applicant with a loan rate that a lending institution will mediate, thereby empowering the loan applicant to make the best loan rate offer to a lending institution that the lending institution will accept, the system comprising:
an application server connected to a communications network, the application server configured to receive application data from the loan applicant via the communications network;
a loan information database comprising loan data for a plurality of loans offered by a plurality of lending institutions, the loan information database being connected to the application server, the loan information database providing the application server with loan data; and
a conforming loan server programmed to process conforming loans, the conforming loan server being connected to the application server and the loan information database;
wherein upon determination that the loan applicant qualifies for a conforming loan, the application data is sent to the conforming loan server to be processed and upon determination that the loan applicant does not qualify for a conforming loan, the application server filters the loan data to determine the loan rates for which the loan applicant qualifies and to determine loan rates a lending institution will mediate for the loan applicant, upon which the application server sends a signal to the loan applicant via the communications network indicating the best available loan rates, the application server receives a selection signal from the loan applicant indicating the selected loan rate, and the application server provides a lending institution with the application data and the loan rate selected by the loan applicant.

12. The system of claim 11 wherein the loan information database is connected to the communications network and obtains loan data for a plurality of loans via the communications network.

13. The system of claim 12 wherein the loan data is located on a plurality of websites operated by a plurality of lending institutions, the plurality of websites being accessible via the communications network.

14. The system of claim 11 wherein the loan application server obtains the loan data for a plurality of loans.

15. The system of claim 14 further comprising a terminal connected to the application server, the terminal disposed to facilitate the entry of loan data for a plurality of loans.

16. A method of providing a loan applicant with a loan and a lending institution that will mediate the loan, the method comprising:
receiving application data from a loan applicant;
receiving loan data from a loan information database, the loan data comprising eligibility requirements and loan terms;
comparing the application data and the loan data to determine loans for which the applicant is eligible;
filtering the loans for which the applicant is eligible to determine loans for which a lending institution will mediate the terms;
filtering the loans for which a lending institution will mediate the terms to determine the best loans available to the loan applicant;
sending a signal to display a plurality loan rates and loan types available to the applicant;
receiving a selection of a loan from the loan applicant; and
notifying a lending institution that will mediate the loan selected by the loan applicant.

17. The method of claim 16 further comprising the step of obtaining a credit score for the loan applicant and adding the credit score to the application data.

18. The method of claim 17 further comprising the step of:
computing additional application data from the application data and adding the additional application data to the application data;
wherein the step of comparing the application data and the loan data includes using the additional application data and the credit score.

19. The method of claim 18 further comprising the step of:
determining if the loan applicant qualifies for a prime or a sub-prime loan;
wherein the loan data is divided into loan data for prime loans and loan data for sub-prime loans.

20. The method of claim 16 where only those loan rates and loan types identified to be the best available to the applicant are able to be selected by the applicant.

21. The method of claim 20 wherein only those loan rates and loan types identified to be the best available to the application are displayed to the applicant.

22. The method of claim 20 further comprising the step of providing the lending institution with the loan data for all of the loans for which a lending institution will mediate the terms.

23. The method of claim 16 further comprising the step of notifying the loan applicant that a lending institution will mediate the loan.

24. A method of providing loan applicant leads to a lead buyer, the method comprising:
receiving application data from a loan applicant;
receiving loan data from a loan information database, the loan data comprising eligibility requirements and loan terms for a plurality of loans from a plurality of lending institutions;
comparing the application data and the loan data to determine loans for which the applicant is eligible;
filtering the loans for which the applicant is eligible to determine loans for which the lead buyer is interested in mediating the terms;
filtering the loans for which the lead buyer is interested in mediating the terms to determine the best loans available to the loan applicant;
sending a signal to display to the loan applicant the best loans available;
receiving a selection of a loan from the loan applicant;
notifying the lead buyer of the loan applicant's application data and the loan selected by the loan applicant.

25. The method of claim 24 wherein the lead buyer is different from the plurality of lending institutions.

26. The method of claim 24 further comprising the step of selecting a lead buyer from plurality of lead buyers in a database of lead buyers.

27. The method of claim 26 wherein the lead buyer is selected from the plurality of lead buyers based on the ability of the lead buyer to mediate the loans for which the loan applicant is eligible.

28. The method of claim 27 wherein the plurality of lead buyers comprises a second plurality of lending institutions.

29. The method of claim 28 wherein the second plurality of lending institutions comprises different lending institutions than the plurality of lending institutions.

30. A computer program product comprising:
a computer readable medium having computer logic for enabling at least one processor in a computer system to facilitate a loan applicant in finding a loan mediated by a lending institution;
means for receiving loan applicant data;
means for receiving loan data;
means for filtering loan data to obtain a plurality of eligible loans based on the loan applicant data;
means for filtering the eligible loans to obtain available loans based on lending institutions willing to mediate a particular loan;
means for filtering the available loans to determine a best loan for each of a plurality of loan types;
means for causing a display to display the best loan for each of a plurality of lean types to the loan applicant;
means for receiving a selection by the applicant; and
means for notifying a lending institution of the selection by the applicant.

31. The computer program product of claim 30 further comprising means for retrieving a lean data from a database of loan data.

32. The computer program product of claim 30 further comprising:
means for obtaining a credit history of the loan applicant; and
means for incorporating the credit history with the loan applicant into the loan applicant data.
